(19) United States
(12) Patent Application Publication
(10) Pub. No.: US 2014/0081824 A1
(43) Pub. Date: Mar. 20, 2014

(54) Method for forecasting and likelihood estimation in technology development through means of a derivatives trading exchange, funding of prize amounts for incentivizing technology development through same trading exchange, and incentivizing development of high-quality inducement prize contests

(71) Applicant: Jeremy Daniel McLain, Kenvil, NJ (US)

(72) Inventor: Jeremy Daniel McLain, Kenvil, NJ (US)

(21) Appl. No.: 14/028,573

(22) Filed: Sep. 17, 2013

Related U.S. Application Data
(60) Provisional application No. 61/701,804, filed on Sep. 17, 2012.

(51) Int. Cl. G06Q 40/04; G06Q 30/02

(52) U.S. Cl. CPC G06Q 40/04; G06Q 30/0207
USPC 705/37

(57) ABSTRACT

The present invention is a method for forecasting and likelihood estimation in technology development through means of a derivatives trading exchange, funding of prize amounts for incentivizing technology development through same trading exchange, and incentivizing development of high-quality Inducement Prize Contests through creation and trading warrants giving the warrant owner rights to issue an IPC prize funded by the derivatives trading exchange.

### CROSS-REFERENCE TO RELATED APPLICATIONS

This application claims the benefit of provisional application No. 61/701,804, filed on Sep. 17, 2012.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of business methods. More particularly, the present invention is in the technical field of financial methods for funding of inducement prize contests.

Thus far in the funding and finance of inducement Prize Contests (IPC), sponsors with philanthropic or technically difficult requirements have funded the prize purse directly or bought prize indemnity insurance to fund the prize outlay. A challenge of financing the prizes is handicapping or estimation of technology development over a time horizon. In formulation of a technical challenge presents several difficulties. First, choosing the right technical parameters is essential to a successful prize. At first it may seem to be an easy task but in practice it is not. The parameters have to measureable enough to know if a contestant has clearly demonstrated the technical capability or not. Setting the threshold is also a challenge. If it is too hard, many contestants would not even attempt to solve the prize contest. It the challenge is too easy, then the prize would be solved too quickly and would not advance the state-of-the-art enough to justify the use of an IPC as a method to demonstrate the capability. More traditional incremental improvement methods would be better to develop such technologies.

Secondly, from a financing perspective, there are not enough instances to develop actuarial tables to develop insurance vehicles to pay for the IPC. From an insurability perspective, there is also much difficulty to the estimation of outcomes due to present and prospective technological development uncertainty. In addition, the development of technology is very context dependent depending on many market factors.

Thirdly, in traditional IPCs, the few technical parameters are usually fixed at a single trigger threshold. Fourthly, there is little or unclear incentives for development of well-formulated and executed prizes versus badly formulated and executed IPCs.

### SUMMARY OF THE INVENTION

The present invention is a method for forecasting and risk estimation in technology development through means of a derivatives trading exchange, funding of prize amounts for incentivizing technology development through same trading exchange, and incentivizing development of high-quality Inducement Prize Contests through creation and trading warrants giving the warrant owner rights to issue an IPC prize funded by the derivatives trading exchange.

### BRIEF DESCRIPTION OF THE DRAWING

FIG. 1 Shows the overall inventive concept. It consists of several elements which work together to achieve the desired effects.

FIG. 2: Shows the method whereby implied market estimated probabilities of the technical parameter thresholds being breached and from there estimating a likely technical development path that the technology will follow over time.

FIG. 3: Shows method whereby prize contests can be funded through the use of derivatives trading.

FIG. 4: Shows method of creation of prize commissioning rights warrants and subsequent trade on a secondary exchange.

FIG. 5: Shows method whereby warrant holder can exercise his rights and create a prize contest funded through derivatives trading

FIG. 6: Shows display output of a 2 parameter (each with 3 thresholds) and 3 expirations which creates 27 types of derivative contracts which could trade tor this particular issuance.

FIG. 7: Notional Example of Ansari X-Prize betting odds type exchange mechanism for 2 parameter (3 thresholds per parameter) and 3 expirations.

FIG. 8: Shows Prize Escrow amounts for 2 parameter (3 thresholds per parameter) and 3 expirations IPC.

FIG. 9: Shows technology development forecast of Parameter A vs. Parameter B vs. Expiry

FIG. 10: Shows notional implied probability that thresholds will be breached prior to Expiry for the Ansari X-Prize example

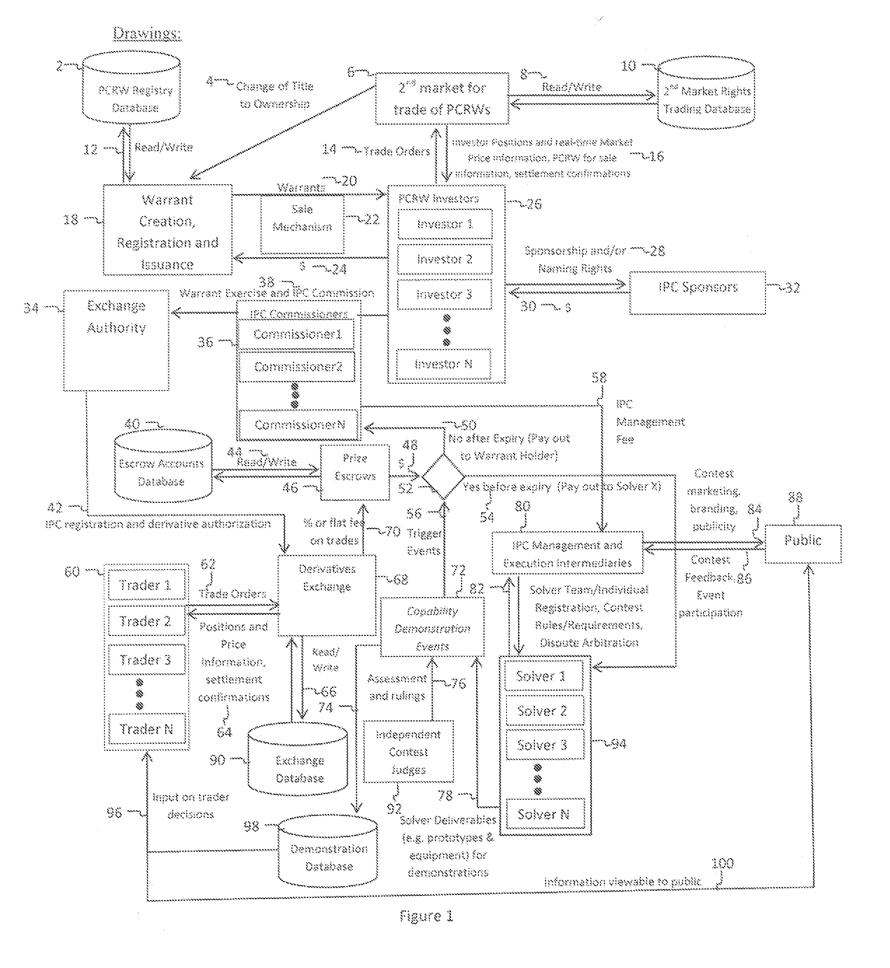

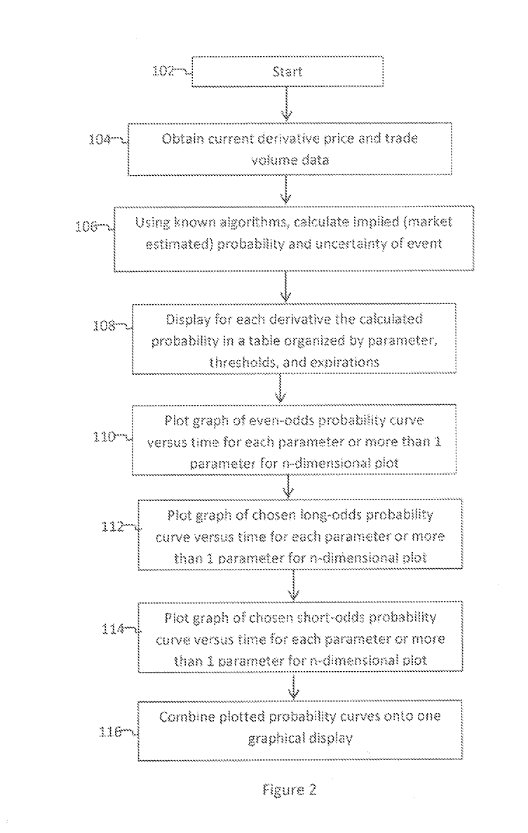

### DETAILED DESCRIPTION OF THE INVENTION

### Definitions of Terms

Inducement Prize Contest: Sometimes referred to as challenge awards or challenges, is a competition that awards a cash prize for the accomplishment of a feat, usually of engineering or technology development.

Traders: Traders buy and sell derivatives contracts via the derivatives exchange.

Solvers: As with traditional IPCs, solvers are individual and team participants in developing technologies to win the IPC and map in doing so reap the prize.

Prize Commissioner: Holder of an executing IPC via an exercised warrant

Prize Commissioning Rights Warrant (PCRW) holder: An owner of a unexercised warrant which gives rights to create an IPC backed by derivatives trade on the derivatives exchange.

Exchange Authority: organization which manages the derivatives exchange, creates, registers and sells PCRWs to investors and authorizes derivatives trade for exercised PCRWs.

Independent Contest Judges: Independent agents who act to assess and role on contest prize demonstration attempts according to rules of IPC.

IPC management and Execution Intermediaries: Organizations contracted by Prize Commissioners to manage the execution of the IPC. Also assist in contest concept and parameterization.

IPC Sponsors: Organizations or individuals who pay for a sponsorship of the IPC.

IPC Name Sponsor: Organization or individual who pays for a naming rights to the IPC.

Prize Escrow: Accounts where prize money is held until expiration of the derivative or an event is triggered.

Parameter: Variable which will be measured and assessed in IPC Capability Demonstration Events.

Threshold: Value of Parameter which will trigger a prize being won by the Solver.

Expiry: Expiration date for derivatives and prizes to be claimed

Public: Members of the public

### Description

In order to overcome the several short-comings of “traditional” IPC formulation, financing, and execution, several new methods are presented to improve the IPC as a technology development tool.

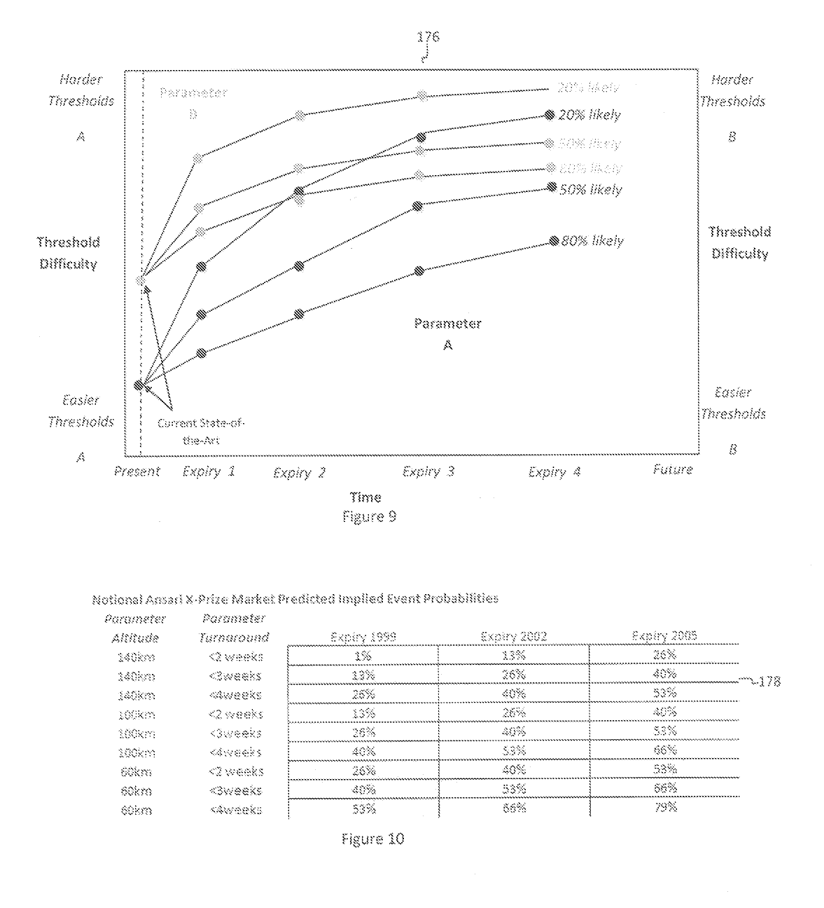

First, in order to estimate the risk and probability of any technical development outcome, financial derivatives and an exchange for their trading would be used to develop a market perceived probability of a given technology capability timeline. As such would be an estimated probability, it is not to say that It would be the ‘real’ probability of a technology capability development timeline. This would like any other probability which is not knowable with absolute certainty, but with a certainty based on sample size. In addition, it would represent the market estimate or consensus of what it predicts as the most likely path of technology development, but the actual path is by no means known with absolute certainty. As there will almost always be a difference between the estimate and reality, the better traders would be able to make more return off the mis-estimation of the total market. In developing the forecast, the first step is to obtain current derivative price and trade volume data 104. Using known algorithms already in public domain, calculate implied market estimated probability and uncertainty of event 106. In this case, the event would be that a capability demonstration breaches the threshold or thresholds stipulated in the derivatives contract before the expiration date of the contract. Then the calculated probabilities would be displayed in a tabular format organized by parameter, thresholds and expiries 108, 174. The next steps would be to plot a graph of the even-odds (or 50% likelihood) curve and long and short odds (some trader chose value>50% and >50%) curves 110, 112, 114. These curves would be combined onto one graphical display 116, 176 (FIG. 9).

Secondly, as part of derivatives exchange, a percentage or flat fee could be assessed to fund the IPC prize incentive money or something else of value such as bonds or equities. As an illustrative example, at each parameter set, a 5% commission could utilized to fund a prize. To further illustrate, if the notional value of all the contracts on the derivatives exchange is $10 B (which would only represent [Total derivatives (notional amount): $182.2 trillion (SECOND QUARTER, 2008) just in US market] 0.005 % of derivatives market share, that would mean $500 M of prize incentives for technical or other achievements. The incentives could be spread across the trigger thresholds of each parameter or lumped together at the consensus point predicted by the derivatives exchange. Such a fee would be a one-time assessment upon creation of the each derivative contract or would be assessed for each subsequent trade of the contract. In the latter case, a lower fee would be better to encourage trade volume which would make up the difference. The unclaimed prize money would be kept by the warrant holder 140. This would incentivize the warrant holder to make the IPC challenging enough to be useful as a technological development tool while at the same time not too difficult as to not attract enough traders, which would be needed to fund the prize but also pay return to the warrant holders (see description below). To estimate the technology development path given a derivatives exchange where contracts are traded, the first step is to obtain current derivative price and volume data 104 and then utilizing known algorithms, a computer-implemented calculation 106 would be made to convert the value into an implied probability of the event happening tor each derivative. Then a table would be generated to show probabilities for all derivatives traded for the IPC 108. A graph of probable technology development path can be generated 110 from the table. Furthermore, un-even-odds paths could also be calculated for both a long-odds plot 112 and short-odds plot 114 to give a forecast of the development as shown in FIG. 9.

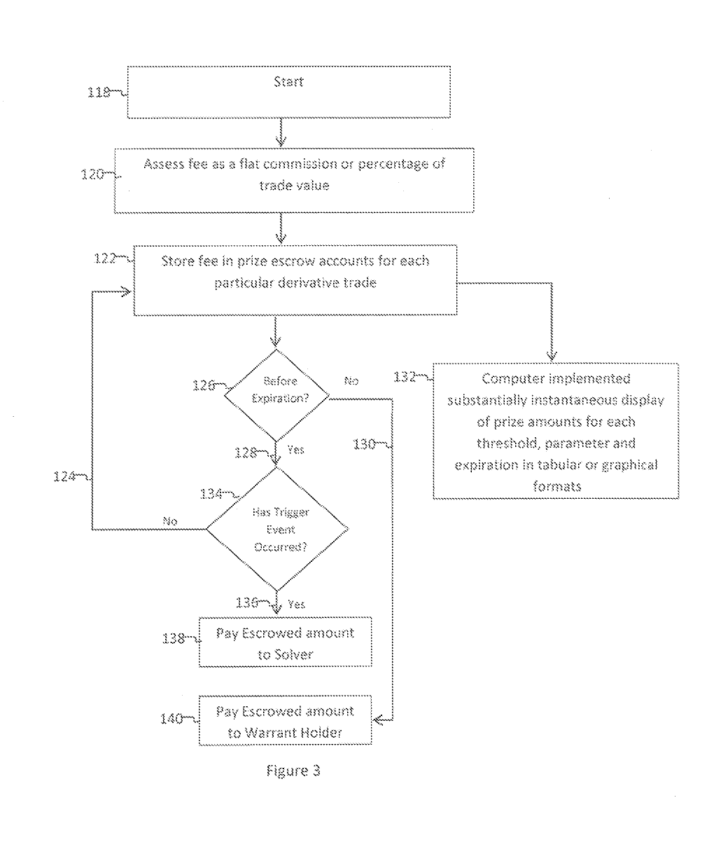

In order to adequately fund IPC prize monetary amounts, a method FIG. 3 is presented to accomplish funding of the IPC. First given a derivatives exchange previously describes, a fee or assessment for trades would be imposed on each derivative contract 120. It would either be assessed upon first creation of the contract between buyer and seller and/or be a fee assessed for each time the contract is subsequently sold or traded. The fees would be kept in escrow accounts 46 for each threshold 174 (FIG. 8). These accounts represent the “purse” of the IPC. As solvers demonstrate technical accomplishments which trigger parameter thresholds, those lines are paid as prizes to those solvers 54, 138. If the line expires before a trigger event then the purse is paid to the warrant holder 50, 140. The system would encourage warrant holders to make the IPCs challenging enough to advance technology or solve other difficult problems. Conversely, the IPC has to be balanced enough to attract public 88, solver 94 and especially trader 60 interest. If the IPC is impossible, it would not attract traders 60 (both buyers and sellers) to be a successful issuance. Thus it is meant to bring a market discipline to the formulation and execution of IPC contests. The warrant holders or commissioners 36 are in competition with one another for trades (traders making bets), public interest 88, public sponsorships 32, and solver 94 attentions (see discussion below). Such a market would encourage a competent and professionalization of IPC management. In contrast to traditional IPCs, the fractionalization of the purse can afford a “fuzzy” payoff to the solver community. In traditional IPC, it is usually a contest where winner takes all with crossing the thresholds all performance parameters to win the payoff. In the presented form, multiple thresholds for each parameter by multiple deadlines can be set to create purses for ‘low hanging fruit’. For example Team A could breach and win a few thresholds while team B later breaches harder thresholds. In winner-take-all scenario, this would not be the case. In the present solution, the prize amounts would be displayed versus parameter and thresholds as shown 174 (FIG. 8). This would give clear market signal to solver community where the center of mass of any given parameter arid more desired parameter to be solved versus lower priority parameters.

Furthermore, in traditional IPCs, the conditions to be met are binary in nature to confirm whether a solver has demonstrated the conditions to be met. With the present invention, the payoff could be graduated into multiple parameters simultaneously and across multiple deadlines, each with different incentives based on what the market has predicted. As an example, in May 1996, the Ansari X-prize of $10 M was created to incentivize cheaper private space flight. The contestants had to show that they could fly a vehicle into space (defined as 100 km altitude above sea-level) with a 2nd flight turn-around time of less than 2 weeks. The prize was won in 2004. FIG. 7 shows what the IPC could have looked like trading as a derivatives family. As can be seen, the market could have estimated that the prize would be won approximately around 2004 (close to even odds around expiry 2005). Each derivative would have traded as variable 2 parameters. Let's say 60 km altitude and 4 weeks turn-around time winch would be the easiest thresholds (and therefore premiums costlier) and 140 km high with 2 week turnaround with cheaper premiums because the harder thresholds would be harder to breach. The solvers could make multiple attempts at the prize which would be divided based on which conditions have been triggered. For instance, a solver could have gotten the 80 km/4-week turnaround which could fund further research to attempt for the higher requirement prizes later. If a solver does do that, it would also affect the value of non-triggered derivative contracts which would be outstanding 96. Such events would afford traders an opportunity to make (or lose) money based on what each thinks will happen in the future. Mismatches between the market-estimated outcomes and the real outcomes would be exploited by the best-performing traders.

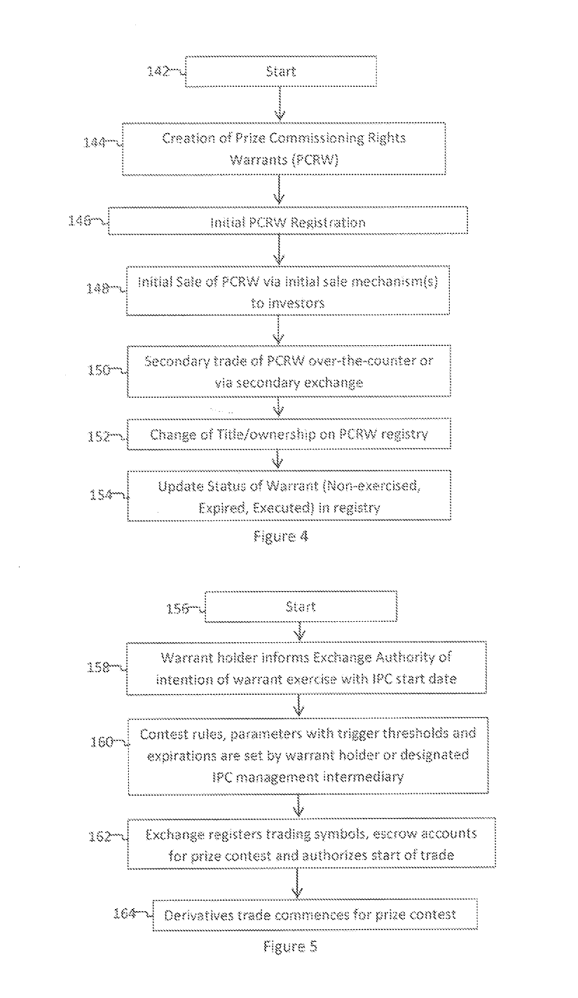

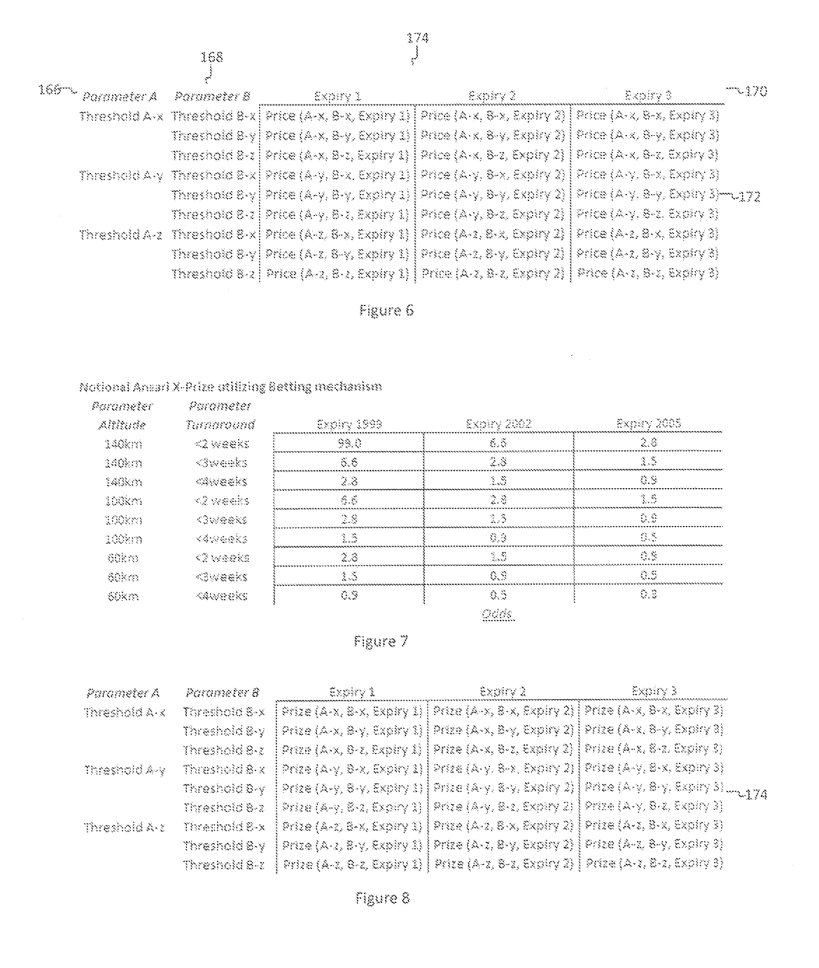

As of now, most Inducement Prize Contests are funded through philanthropy or government agencies. Wealthy individuals and agencies put forth prizes in areas that are of interest to them. However, at first glance it would appear rather easy to formulate an IPC. Upon further reflection, it is more challenging. A balance must be struck between the difficulty or ease of which the problem could be solved within the envisioned timeframe. Other considerations would be if the problem could attract enough public interest as well as solver interest in addition to figuring out how much to give as the incentive. Furthermore, the parameters or conditions to be met must be objectively measurable by demonstration 72. Some unsuccessful prizes in the past were unsuccessful because the rules or the conditions to be met were too subjective. In the current embodiment, the PCRWs would be auctioned off 22 to investors 26 who cart either turn around to sell to other investors in a secondary market 6 (Over-the-Counter or via an exchange) or choose to exercise them as IPCs 38. Exercise of PCRWs to convert to IPCs would be encouraged in a number of ways. First, an expiration on the life of the warrant can be attached to it. In addition, subsequent auctioning of new warrants 18 periodically would dilute the value of any outstanding warrants. Such subsequent issuance would encourage investors to exercise their warrants. The executed IPC contests and prize formulations would also be a market. The formulation of a “bad” prize statement would punish those warrant holders while formulation of “good” prizes which have robust trader and solver participation and public interest or excitement would be rewarded by taking trading share from the bad prizes. The parameters would have to be designed to attract narrow trader spreads and liquidity. If the parameters are poorly designed, then there would be a mismatch of buyers and sellers of the derivatives which would cause market failure of the issuance. Thus, like any other market, a market discipline would be enforced which would work 10 improve subsequent IPC formulation. The aforementioned philanthropists could choose to invest in these warrants which could multiply the incentives if formulated competitively. For instance, if the philanthropist has only $10 M that he wants to put toward a prize, he could buy warrants with that money instead and execute an IPC funded by the derivatives exchange. If the prize is a more popularly traded issuance then the incentive garnered for that IPC would be more than the original 10 M prize envisioned. Furthermore, a philanthropist could structure the unclaimed escrow to be used for the more difficult longer dated threshold bets. FIG. 4 shows the method by which Prize Commissioning Rights Warrants are created and issued to investors. First, the exchange authority creates a PCRW 144 and then registers it 146. The authority sells to investors 148 through an auction or other sales mechanisms 22. The investors can resell their warrants to other investors 150 through an exchange or over-the-counter market 6. Upon the resale of a warrant the registry is updated 152 with the change of ownership title. The status of the warrant whether non-exercise, expired, or in execution is updated in the registry 154.

In exercising warrants 156, 38, investors inform the exchange authority of intention to exercise with an IPC formulation and start date 158. IPC rules parameters with trigger thresholds and expirations are set by prize commissioner or his designated IPC management intermediary 160. The exchange authority sets up trading symbols and prize escrow accounts for the IPC and authorizes start of derivatives trade 162. Derivatives are then traded on the exchange 164.

In addition, such IPCs executed could either have a maximum run-time or run indefinitely. Such considerations would have to be assessed when auctioned to investors. For instance, terms such as execution time limits would be less valuable than those without limit. Similarly those that stipulate that IPC has a limited timeframe would be less valued than those which could be “evergreens” or run indefinitely over the timeline of some technological lifespan. As an example of this, an otherworldly prize could be formulated thus: sustain X number of adult-size residents on the moon for Y time. As the number of moon colonists is almost limitless at least in relation to the present time, and length of time that a moon colony could exist would also be indefinite, such an IPC can update itself as the colony gets established. As contestants mature the colony to a large number of people, the IPC would most probably lose trading interest and any incremental improvement would not be incentivized that much (as traders would have moved on to other prizes to trade upon, there would be sparse trading on the IPC derivatives in far future years). Thus such an incentive could still have a residual effect for a long time. Although in the example as the colony matures, it would be more difficult to determine to whom to pay the prize in the case that multiple organizations make up the moon colony. In such case the technological development would have entered into a flattening incremental phase which would be developed by other more traditional research and development investment ecosystems.

Inducement Prize Warrants would entail several different types of rights to the holder. Several types of rights can be envisioned. Firstly, the most limited type of warrant (type A to abbreviate) would entail an exercise start time limit and an IPC execution time limit. For example, from issuance of warrant it would stipulate a time limit in which the holder would have to exercise the warrant to create and start the IPC. To illustrate, a non-limiting time limit for exercising could be 10 years. The second time limit would involve the actual IPC execution time. This would be the time in which the contest would take place. An example would also be 10 years. Thus in this example the maximum time for the warrant would be 20 years (10 years to exercise the warrant and then 10 years in which the IPC is executed).

A second type (type B) of warrant rights combination would be in which the warrant exercise time limit would be in place but the IPC contest execution time could run indefinitely.

A third type (type C) of rights combination would involve the opposite arrangement in which the time limit to exercise the warrant would be indefinite and a time limit would be imposed to execute the IPC.

A fourth (type D) least encumbered rights combination would be in which both time limits are indefinite.

In addition to the PCRW, the sponsorship or naming rights 28 can be bundled with the PCRW or sold separately. The investors in the warrant would have to calculate whether to add sponsorship or not. Sponsorship could be a critical component to the success or failure of the contest IPC issuance though. Name recognition from a brand sponsor could attract more trader interest and activity, as well as stoke public 88 and solver 94 interest in the particular IPC contest.

The exchange mechanism 68 utilized by the exchange authority 34 may comprise several different known types. Firstly, it could use sports book betting methods and price or odds quotations. In this case, it would entail the use of a system for transferring stakes of traders such as described by U.S. Pat. No. 7,233,922 and related art. A second type of instrument which could be utilized by traders is an event triggered swap modeled and traded like existing credit default swaps. Instead of a credit event such as a default triggering the swap in this case of the derivatives contract, the capability demonstrations would create trigger events which would breach thresholds stipulated in the swap contract. Independent Contest Judges 92 would make rulings 76 to assess whether a threshold has been triggered. A third trading instrument or mechanism which may be utilized are financial options. In this case the strike price would not be used as the underlying reference but the thresholds of each parameter would act as strike prices. The traders would buy and sell puts and calls and the crossing point between the call line and the put line would be seen as the consensus outcome predicted by the market. Any mismatches in the values would quickly be arbitrated by the traders to close any price gaps. The trigger events would change the value of the options over time 96. Other known, financial instruments and trade mechanisms within finance and other domains may also be utilized.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. A method for technology development forecasting via computer-implemented financial trading exchange comprising steps:
Obtain current derivative price and trade volume data;
Using known algorithms, calculate implied (market estimated) probability and uncertainty of event;
Display for each derivative the calculated probability in a table organized by parameter, thresholds, and expirations;
Plot graph of even-odds probability curve versus time for each parameter or more than 1 parameter for n-dimensional plot;
Plot graph of chosen long-odds probability curve versus time for each parameter or more than 1 parameter for n-dimensional plot;
Plot graph of chosen short-odds probability curve versus time for each parameter or more than 1 parameter for n-dimensional plot; and
Combine plotted probability curves onto one graphical display.

2. A method for funding Inducement Prize Contest via computer-implemented financial trading exchange comprising steps:
Assess fee as a flat commission or percentage of trade value;
Store fee in prize escrow accounts for each particular derivative trade;
Determine that the contract has expired;
Determine that the trigger event has occurred; and
Pay escrowed amount to Solver.

3. The method of claim 2 where contract has not expired and trigger event has not occurred comprising steps:
Assess fee as a flat commission or percentage of trade value;.
Store fee in prize escrow accounts for each particular derivative trade;
Determine that the contract has not expired;
Determine that the trigger event has not occurred; and
Store fee in prize escrow accounts tor each particular derivative trade.

4. The method of claim 2 where contract has expired and trigger event has not occurred comprising steps;
Assess fee as a flat commission or percentage of trade value;
Store fee in prize escrow accounts for each particular derivative trade;
Determine that the contract has expired;
Determine that the trigger event has not occurred; and
Pay escrowed amount to Warrant holder.

5. The method of claim 2 comprising steps:
Assess fee as a flat commission or percentage of trade value;
Store fee in prize escrow accounts for each particular derivative trade;
Display substantially instantaneous prize amounts for each threshold, parameter and expiration in tabular or graphical form.

6. A method for securitization of Inducement Prize Contest commissioning rights comprising steps:
Create Prize Commissioning Rights Warrants (PCRW);
Register new PCRWs:
Sale of PCRW via initial sale mechanism(s) to investors;
Allow trade of PCRWs over-the-counter or via secondary exchange;
Change title to PCRW via registry as ownership changes; and
Update status of warrant in registry
